(19) United States
(12) Patent Application Publication
(10) Pub. No.: US 2026/0338471 A1
(43) Pub. Date: Oct. 29, 2026

(54) HEATING FURNACE AND PRODUCTION SYSTEM

(71) Applicant: JEREH NEW ENERGY TECHNOLOGY CO., LTD., Tianshui (CN)

(72) Inventors: Shuzhen CUI, Tianshui (CN); Hongfa CHEN, Tianshui (CN)

(73) Assignee: JEREH NEW ENERGY TECHNOLOGY CO., LTD., Tianshui (CN)

(21) Appl. No.: 19/205,489

(22) Filed: May 12, 2025

Related U.S. Application Data
(63) Continuation of application No. PCT/CN2025/092075, filed on Apr. 29, 2025.

(51) Int. Cl. F27B 1/08; F27B 1/14; F27B 1/20; F27B 1/21; F27D 99/00

(52) U.S. Cl. CPC F27B 1/08; F27B 1/14; F27B 1/20; F27B 1/21; F27D 99/0006

(57) ABSTRACT

A heating furnace and a production system are provided. A furnace body of a heating furnace is provided with an accommodation space. A second electrode and at least a part of a first electrode are disposed in the accommodation space. In a radial direction of the furnace body, the first electrode, the second electrode, and a sidewall of the furnace body are successively arranged at intervals. A first channel is formed between the first electrode and the second electrode, a second channel is formed between the second electrode and the sidewall of the furnace body, and the second channel and the first channel extend in an axial direction of the furnace body and communicate with each other to form a material channel.

### CROSS-REFERENCE TO RELATED APPLICATIONS

This application is a continuation of and claims the benefit of priority to PCT International Patent Application PCT/CN2025/092075, filed on Apr. 29, 2025, entitled “HEATING FURNACE AND PRODUCTION SYSTEM,” which is herein incorporated by reference by its entirety.

### TECHNICAL FIELD

This application relates to the field of lithium battery processing, and specifically to a heating furnace and a production system.

### BACKGROUND

Lithium batteries have developed rapidly in the fields of electric vehicles and energy storage, and negative electrode materials are one of critical materials for lithium batteries. Artificial graphite is widely used in the negative electrode material, and graphitization refers to a high temperature heat treatment procedure in which amorphous turbostratic structure carbon is converted into a three-dimensional ordered graphite crystalline structure.

### TECHNICAL PROBLEM

A heating furnace, a production system, and a battery preparation system are provided, to solve a problem of low energy utilization of the heating furnace.

### SUMMARY

To achieve the foregoing objective, according to a first aspect, this disclosure provides a heating furnace, including: a furnace body provided with an accommodation space; a first electrode; and a second electrode having a polarity opposite to that of the first electrode, where at least a part of the first electrode is disposed in the accommodation space; the second electrode is disposed in the accommodation space; and in a radial direction of the furnace body, the first electrode, the second electrode, and a sidewall of the furnace body are successively arranged at intervals, so that a first channel is formed between the first electrode and the second electrode, a second channel is formed between the second electrode and the sidewall, and the second channel and the first channel extend in an axial direction of the furnace body and communicate with each other to form a material channel.

In some example implementations, the furnace body is further provided with a material inlet and a material outlet; and one end of the first channel communicates with the material inlet, the other end of the first channel communicates with one end of the second channel, and the other end of the second channel communicates with the material outlet.

In some example implementations, the heating furnace is a vertical heating furnace, and both the material inlet and the material outlet are disposed at a bottom of the furnace body.

In some example implementations, the heating furnace further includes: an adjustment unit configured to adjust an overlapping length of the first electrode and the second electrode in the axial direction of the furnace body.

In some example implementations, the adjustment unit is configured to drive at least one of the first electrode and the second electrode to move in the axial direction of the furnace body.

In some example implementations, the heating furnace further includes: a clamping member configured to fix the first electrode through clamping or release the first electrode, so that the first electrode moves in the axial direction of the furnace body.

In some example implementations, the clamping member is configured to clamp a part that is of the first electrode and that is located outside the accommodation space; the furnace body further includes a furnace cover; and the heating furnace further includes: an insulating member, located between the clamping member and the furnace cover.

In some example implementations, the second electrode includes an annular structure, at least a part of the first electrode is located in an annular space of the second electrode, and the annular space is configured to form the first channel.

In some example implementations, the first electrode includes a cylindrical structure or a square columnar structure; and/or at least one of the first electrode and the second electrode is a graphite electrode.

In some example implementations, the heating furnace further includes: a thermal insulation structure, disposed around an outer surface of the sidewall of the furnace body.

In some example implementations, the heating furnace further includes: a power supply apparatus configured to supply power to the first electrode and the second electrode, where the power supply apparatus is electrically connected to the first electrode through a first power supply conductor, and is electrically connected to the second electrode through a second power supply conductor.

In some example implementations, the heating furnace further includes a gas inlet for introducing shielding gas and a gas outlet, where both the gas inlet and the gas outlet communicate with the accommodation space.

According to a second aspect, this disclosure further provides a production system, including a heating furnace capable of performing a graphitization process, where the heating furnace includes: a furnace body, provided with an accommodation space; a first electrode; and a second electrode, having a polarity opposite to that of the first electrode, where at least a part of the first electrode is disposed in the accommodation space; the second electrode is disposed in the accommodation space; and in a radial direction of the furnace body, the first electrode, the second electrode, and a sidewall of the furnace body are successively arranged at intervals, so that a first channel is formed between the first electrode and the second electrode, a second channel is formed between the second electrode and the sidewall, and the second channel and the first channel extend in an axial direction of the furnace body and communicate with each other to form a material channel.

In some example implementations, the furnace body is further provided with a material inlet and a material outlet; and one end of the first channel communicates with the material inlet, the other end of the first channel communicates with one end of the second channel, and the other end of the second channel communicates with the material outlet.

In some example implementations, the heating furnace is a vertical heating furnace, and both the material inlet and the material outlet are disposed at a bottom of the furnace body.

In some example implementations, the heating furnace further includes: an adjustment unit configured to adjust an overlapping length of the first electrode and the second electrode in the axial direction of the furnace body.

According to a third aspect, this disclosure further provides a production system, including a granulation unit that performs a granulation process on a prefabricated material to obtain a coating material, a precarbonization unit that performs a precarbonization process on the coating material to obtain a precarbonized material, and a plurality of heating units that perform a graphitization process and/or a high temperature carbonization process on the precarbonized material, where the granulation unit, the precarbonization unit, and the heating unit are successively connected.

Both the granulation unit and the precarbonization unit extend and are disposed in a first direction, the plurality of heating units are arranged and disposed in a second direction different from the first direction, and in the first direction, the granulation unit and the precarbonization unit are disposed on a same side of the plurality of heating units.

In some example implementations, the production system includes a plurality of granulation units and a plurality of precarbonization units. One granulation unit and one precarbonization unit are arranged in the first direction and connected to form a first entirety, and each first entirety is connected to one heating unit, or at least two first entireties are connected to one heating unit.

In some example implementations, the production system includes a plurality of granulation units and a plurality of precarbonization units. One granulation unit and one precarbonization unit are arranged in the second direction and connected to form a second entirety, and each second entirety is connected to one heating unit, or at least two second entireties are connected to one heating unit.

In some example implementations, one precarbonization unit includes a first end and a second end disposed opposite to each other in the first direction, and the second end is located between the first end and the heating unit.

In some example implementations, in the second entirety, one end of the granulation unit is flush with the first end, and a projection of the other end of the granulation unit on the precarbonization unit is located between the first end and the second end.

In some example implementations, the production system includes a plurality of granulation units and a plurality of precarbonization units. One granulation unit and one precarbonization unit are arranged in a third direction different from the first direction and the second direction and connected to form a third entirety, and each third entirety is connected to one heating unit, or at least two third entireties are connected to one heating unit.

In some example implementations, the third direction is a direction perpendicular to a ground, and in the third entirety, the granulation unit is located between the precarbonization unit and the ground.

In some example implementations, each heating unit includes at least one heating furnace, and the production system further includes at least one rectifier transformer unit, where each heating furnace is electrically connected to one rectifier transformer unit, or at least two heating furnaces are electrically connected to one rectifier transformer unit.

In some example implementations, when the production system includes a plurality of rectifier transformer units, phases of signals transmitted by adjacent rectifier transformer units are different.

In some example implementations, the production system further includes a power distribution system electrically connected to the rectifier transformer unit, where

the power distribution system, one rectifier transformer unit, and one heating furnace are connected successively to form a power supply path; or

the rectifier transformer unit includes a plurality of output windings, and the power distribution system, one output winding, and one heating furnace are connected successively to form a power supply path; or

the rectifier transformer unit includes a plurality of output windings, and the power distribution system, at least two output windings connected in parallel, and one heating furnace are connected successively to form a power supply path.

In some example implementations, each heating unit includes at least one heating furnace, and the heating furnace includes: a furnace body, provided with an accommodation space; a first electrode; and a second electrode, having a polarity opposite to that of the first electrode, where at least a part of the first electrode is disposed in the accommodation space; the second electrode is disposed in the accommodation space; and in a radial direction of the furnace body, the first electrode, the second electrode, and a sidewall of the furnace body are successively arranged at intervals, so that a first channel is formed between the first electrode and the second electrode, a second channel is formed between the second electrode and the sidewall, and the second channel and the first channel extend in an axial direction of the furnace body and communicate with each other to form a material channel.

In some example implementations, the furnace body is further provided with a material inlet and a material outlet, one end of the first channel communicates with the material inlet, the other end of the first channel communicates with one end of the second channel, and the other end of the second channel communicates with the material outlet.

In some example implementations, the heating furnace is a vertical heating furnace, and both the material inlet and the material outlet are disposed at a bottom of the furnace body.

In some example implementations, the heating furnace further includes: an adjustment unit configured to adjust an overlapping length of the first electrode and the second electrode in the axial direction of the furnace body.

In some example implementations, the granulation unit includes a continuous granulation kettle, the precarbonization unit includes a precarbonization rotary kiln, and the heating unit includes a vertical continuous heating furnace.

In some example implementations, the production system further includes a control system and at least one of a shielding gas system, a cooling system, an exhaust system, and an auxiliary gas system, where the control system is electrically connected to at least one of the shielding gas system, the cooling system, the exhaust system, and the auxiliary gas system.

In some example implementations, the production system further includes a pretreatment unit that performs a pretreatment process on a negative electrode raw material to obtain the prefabricated material, and a finished product preparation unit that performs a finished product fabrication process on a material obtained after the graphitization, where

in the first direction, the pretreatment unit, the granulation unit, and the precarbonization unit are disposed on a same side of the plurality of heating units, the finished product preparation unit is disposed on an opposite side of the plurality of heating units, the pretreatment unit is connected to the granulation unit, and the finished product preparation unit is connected to the plurality of heating units.

### BENEFICIAL EFFECTS

In some example implementations, a first electrode and a second electrode that are successively arranged at intervals in a radial direction of a furnace body are disposed in the furnace body of a heating furnace, a first channel is formed between the first electrode and the second electrode, and a second channel is formed between the second electrode and a sidewall of the furnace body. When the first electrode and the second electrode are energized, a material can be heated by an electric field formed by the first electrode and the second electrode when the material flows in the first channel. Therefore, on the one hand, a spatial volume of the first channel between the first electrode and the second electrode is small, and an amount of materials accommodated in a same time period is small. Compared with a solution in the related technology in which the electrode needs to heat the material in the entire furnace body, in this embodiment, the two electrodes heat the material in the first channel with a higher heating power density, a faster heating speed of the material, and more uniform heating of the material. On the other hand, compared with a solution in the related technology in which a material enters from a top of the furnace body and exits from a bottom of the furnace body, in this embodiment, the material flows in the first channel and the second channel, a flow path of the material is longer, and the material is heated at a high temperature in the furnace body for a longer time, so that the material can fully use heat in the furnace body, thereby improving utilization of the heat in the furnace body, and further improving energy utilization of the entire heating furnace.

In some example implementations, both a granulation unit and a precarbonization unit of a production system are arranged and disposed in a first direction, and a plurality of heating units are disposed in a second direction. In this case, the production system is not easy to occupy large layout space in the first direction or the second direction. In addition, in this embodiment, the granulation unit and the precarbonization unit are disposed on a same side of the plurality of heating units, and the granulation unit and the precarbonization unit properly utilize a region on one side of the plurality of heating units. Compared with a solution in which the granulation unit and the precarbonization unit are separately disposed on different sides of the plurality of heating units, in the same-side solution in this embodiment, the production system occupies less layout space. Based on this, in this embodiment, an arrangement manner of the granulation unit, the precarbonization unit, and the plurality of heating units is designed, which can reduce layout space occupied by the production system, thereby reducing factory investment costs and production costs.

In some example implementations, when the granulation unit in this embodiment includes a continuous granulation kettle, the precarbonization unit includes a precarbonization rotary kiln, and the heating unit includes a vertical continuous graphitization apparatus and/or a vertical continuous high temperature carbonization apparatus, the production system in this embodiment can perform integrated continuous production, which has a high degree of automation, greatly reduces energy consumption, and further reduces production costs.

### BRIEF DESCRIPTION OF DRAWINGS

To describe technical solutions in embodiments of this disclosure more clearly, the following briefly describes accompanying drawings. It is clear that the accompanying drawings in the following descriptions show merely some embodiments of this disclosure, and do not constitute an inappropriate limitation on this disclosure. A person skilled in the art may still derive other accompanying drawings from these accompanying drawings without creative efforts. In the accompanying drawings:

FIG. 1 is an example schematic diagram of a structure of a heating furnace according to an embodiment of this disclosure;

FIG. 2 is an example schematic cross-sectional diagram of the heating furnace shown in FIG. 1;

FIG. 3 is an example schematic diagram of material flow in a heating furnace according to an embodiment of this disclosure;

FIG. 4 is an example schematic diagram of another structure of a heating furnace according to an embodiment of this disclosure;

FIG. 5 is an example schematic diagram of still another structure of a heating furnace according to an embodiment of this disclosure;

FIG. 6 is an example schematic diagram of yet another structure of a heating furnace according to an embodiment of this disclosure;

FIG. 7 is an example schematic diagram of a first structure of a production system according to an embodiment of this disclosure;

FIG. 8 is an example schematic diagram of a second structure of a production system according to an embodiment of this disclosure;

FIG. 9 is an example schematic diagram of a first layout of a production system according to an embodiment of this disclosure;

FIG. 10 is an example schematic diagram of a second layout of a production system according to an embodiment of this disclosure;

FIG. 11 is an example schematic diagram of a third layout of a production system according to an embodiment of this disclosure;

FIG. 12 is an example schematic diagram of a fourth layout of a production system according to an embodiment of this disclosure;

FIG. 13 is an example schematic diagram of a connection of a heating unit of a production system according to an embodiment of this disclosure;

FIG. 14 is an example schematic diagram of an electrical connection of a heating furnace of a production system according to an embodiment of this disclosure;

FIG. 15 is an example schematic diagram of an electrical connection of a power distribution system of a production system according to an embodiment of this disclosure; and

FIG. 16 is an example schematic diagram of a structure of a battery preparation system according to an embodiment of this disclosure.

The reference numerals are denoted as follows:
10: Production system;
20: Battery preparation system;
100: Granulation unit;
200: Precarbonization unit;
300: Heating unit;
400: Pretreatment unit;
500: Finished product preparation unit;
600: Rectifier transformer unit;
700: Power distribution system;
800: Control system;
900: Public facility system;
110: First entirety; 120: Second entirety; 130: Third entirety;
101: First workshop; 102: Second workshop; 103: Third workshop; 104: Fourth workshop; 105: Fifth workshop; 106: Material processing transit zone;
210: First end; 220: Second end;
310: Heating furnace;
301: Accommodation space;
302: First channel; 303: Second channel;
311: Furnace body; 312: First electrode; 313: Second electrode; 314: Clamping member; 315: Insulating member; 316: First power supply conductor; 317: Second power supply conductor; 318: Power supply apparatus; 319: Adjustment unit;
321: Thermal insulation structure; 322: Gas inlet; 323: Gas outlet;
3111: Sidewall; 3112: Furnace bottom 3113: Furnace cover; 3114: Material inlet;
3115: Material outlet; 3121: First part; 3122: Second part;
910: Shielding gas system;
920: Cooling system;
930: Exhaust system;
940: Auxiliary gas system;
H1: First direction; H2: Second direction; H4: Radial direction; and H5: Axial direction.

It should be noted that the elements in the accompanying drawings are exemplary and are not drawn to scale.

### DESCRIPTION OF EMBODIMENTS

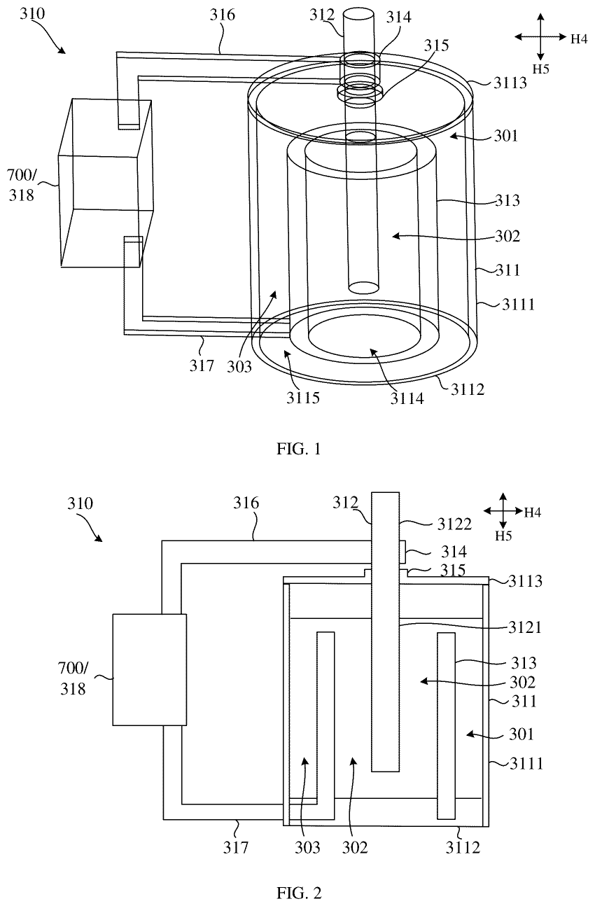

The following describes technical solutions in embodiments of this disclosure with reference to FIG. 1 to FIG. 16. The described embodiments are merely some but not all of embodiments of this disclosure. All other embodiments obtained by a person skilled in the art based on the embodiments of this disclosure without creative efforts shall fall within the protection scope of this disclosure.

The “embodiment” mentioned in this specification means that a specific feature, structure, or characteristic described with reference to the embodiment may be included in at least one embodiment of this disclosure. The term appearing at various locations in this specification does not necessarily refer to a same embodiment, or an independent or alternative embodiment mutually exclusive with another embodiment. A person skilled in the art explicitly and implicitly understands that the embodiments described in this specification may be combined with other embodiments.

In the field of lithium-ion batteries, a production process of a graphite negative electrode material of the lithium-ion battery mainly includes grinding of raw materials, granulation, precarbonization, graphitization, high temperature carbonization, and finishing a product. In the related technology, an Acheson heating furnace used to perform a graphitization process is of an open rectangular structure, and a single-furnace charge batch usually reaches hundreds of tons. Charging, graphitization processing, cooling, and discharge processes are successively performed in a same furnace body. The graphitization process is discontinuous, and a production cycle is about dozens of days, which has low production efficiency. In addition, the Acheson heating furnace uses a large quantity of auxiliary materials as thermal insulation materials, and an amount of the auxiliary materials is 2 to 4 times that of the product. A large quantity of heat energy is used for heating the auxiliary materials, and energy utilization is low, and loss of the auxiliary materials and electricity costs are high.

To resolve the foregoing technical problems, this disclosure provides a heating furnace and a production system. The following describes the heating furnace and the production system in detail with reference to specific embodiments. It should be noted that the embodiments of this disclosure may be presented in various forms. Some examples are described below.

Referring to FIG. 1 and FIG. 2, FIG. 1 is an example schematic diagram of a structure of a heating furnace 310 according to an embodiment of this disclosure, and FIG. 2 is an example schematic cross-sectional diagram of the heating furnace 310 shown in FIG. 1. The heating furnace 310 includes a furnace body 311, a first electrode 312, and a second electrode 313.

The furnace body 311 is provided with an accommodation space 301. The first electrode 312 and the first electrode 313 have opposite polarities, at least a part of the first electrode 312 is disposed in the accommodation space 301, and the second electrode 313 is disposed in the accommodation space 301. In a radial direction H4 of the furnace body 311, the first electrode 312, the second electrode 313, and a sidewall 3111 of the furnace body 311 are successively arranged at intervals, so that a first channel 302 is formed between the first electrode 312 and the second electrode 313, and a second channel 303 is formed between the second electrode 313 and the sidewall 3111 of the furnace body 311. The second channel 303 and the first channel 302 extend in an axial direction H5 of the furnace body 311 and communicate with each other to form a material channel.

It may be understood that the heating furnace 310 may be but is not limited to an electric heating apparatus, a graphitization apparatus, and a high temperature carbonization apparatus. The furnace body 311 of the heating furnace 310 includes the sidewall 3111, a furnace bottom 3112, and a furnace cover 3113. The furnace bottom 3112 and the furnace cover 3113 are disposed on two opposite sides of the sidewall 3111, the sidewall 3111 is enclosed along a circumference of the furnace bottom 3112 to form an annular structure, the sidewall 3111, the furnace bottom 3112, and the furnace cover 3113 form a hollow structure and form the accommodation space 301, and a material can be heated in the furnace body 311 and graphitized. Two or three of the sidewall 3111, the furnace bottom 3112, and the furnace cover 3113 of the furnace body 311 are an integrally formed structure, or three of the sidewall 3111, the furnace bottom 3112, and the furnace cover 3113 are all independent structures and are connected to each other to form the furnace body 311. For example, the sidewall 3111 and the furnace bottom 3112 are an integrally formed structure, and the furnace cover 3113 is independent of the sidewall 3111 and the furnace bottom 3112. For another example, the sidewall 3111, the furnace bottom 3112, and the furnace cover 3113 are connected through clamping, welding, and the like, and the connection region is sealed by using a sealing structure.

It may be understood that both the first electrode 312 and the second electrode 313 are located in the accommodation space 301 of the furnace body 311, and both the first electrode 312 and the second electrode 313 extend in the axial direction H5 of the furnace body 311. The second electrode 313 is disposed between the first electrode 312 and the sidewall 3111 of the furnace body 311. In this case, in the radial direction H4 of the furnace body 311, a first side surface (for example, an inner side surface) of the second electrode 313 is disposed opposite to the first electrode 312, and the first channel 302 is formed between the first side surface and the first electrode 312. A second side surface (for example, an outer side surface) of the second electrode 313 is disposed opposite to the sidewall 3111 of the furnace body 311, and the second channel 303 is formed between the second side surface and the sidewall 3111. The second channel 303 and the first channel 302 are arranged at intervals in the radial direction H4 of the furnace body 311, and both extend in the axial direction H5 of the furnace body 311. The material flows between the first channel 302 and the second channel 303 that are in communication, and a flow path of the material is longer.

It may be understood that the first electrode 312 and the second electrode 313 are two electrodes with opposite polarities. When the first electrode 312 is of a positive electrode structure or an anode structure, the second electrode 313 is of a negative electrode structure or a cathode structure. Alternatively, when the first electrode 312 is of a negative electrode structure or a cathode structure, the second electrode 313 is of a positive electrode structure or an anode structure. When the first electrode 312 and the second electrode 313 are energized, the first electrode 312 and the second electrode 313 form an electric field on the first channel 302 therebetween. When a conductive material flows in the first channel 302, heat can be generated under action of a current and the material can be heated. Compared with a solution of heating the material by using an auxiliary material, the conductive material has higher heat generation efficiency for spontaneous heating. In some examples, the heating furnace 310 in this disclosure may be applied but is not limited to being applied to an application scenario in which the material is heated to 1000 degrees Celsius or 2000 degrees Celsius.

It may be understood that the heated material in this embodiment of this disclosure may be but is not limited to a conductive powder with particles of 0 mm to 3 mm, and the conductive powder can self-conduct electricity and generate heat in an electric field. In some examples, when the conductive material may be a precarbonized powder (for example, a graphite powder), the powder can implement a heating process in the heating furnace 310 in this embodiment of this disclosure.

In the heating furnace 310 in this embodiment of this disclosure, the first electrode 312 and the second electrode 313 that are successively arranged at intervals in the radial direction H4 of the furnace body 311 are disposed in the furnace body 311. The first channel 302 is formed between the first electrode 312 and the second electrode 313, and the second channel 303 is formed between the second electrode 313 and the sidewall 3111 of the furnace body 311. When the first electrode 312 and the second electrode 313 are energized, the material can be heated by an electric field formed by the first electrode 312 and the second electrode 313 when flowing in the first channel 302. Therefore, on the one hand, a spatial volume of the first channel 302 between the first electrode 312 and the second electrode 313 is small, and an amount of materials accommodated in a same time period is small. Compared with a solution in the related technology in which the electrode heats the material in the entire furnace body 311, in this disclosure, the two electrodes heat the material in the first channel 302 with a higher heating power density, a faster heating speed of the material, and more uniform heating of the material. On the other hand, compared with a solution in the related technology in which a material enters from a top of the furnace body and exits from a bottom of the furnace body, in this disclosure, the material flows in the first channel 302 and the second channel 303, a flow path of the material is longer, the material is heated at a high temperature (for example, in a graphitization process, the heating furnace 310 may reach 2000 degrees Celsius or even 2500 degrees Celsius, and in a high temperature carbonization process, the heating furnace 310 may reach 1500 degrees Celsius) in the furnace body 311 for a longer time, so that the material can fully use heat in the furnace body 311, thereby improving heat utilization of the furnace body 311, and further improving energy utilization of the entire heating furnace 310.

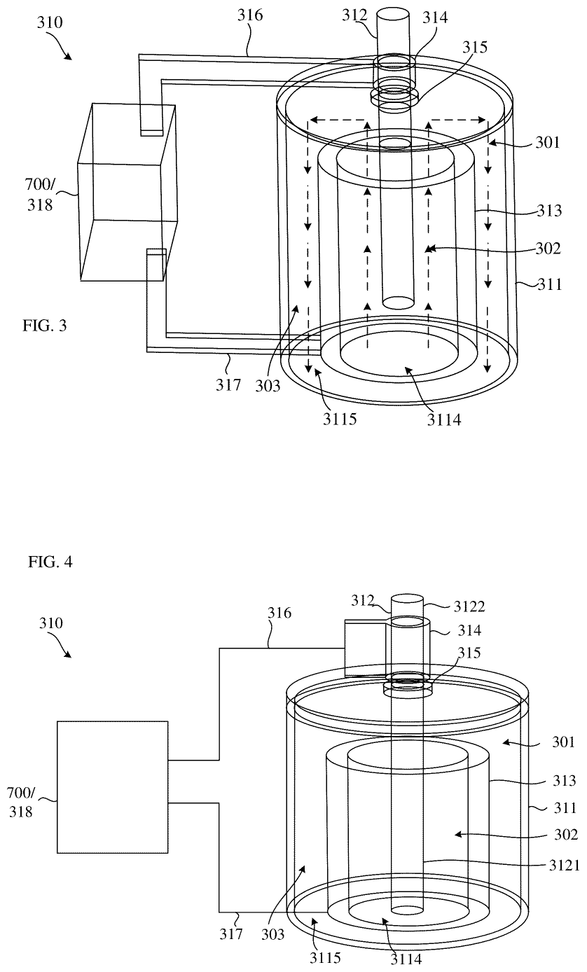

Still referring to FIG. 1, and referring to FIG. 3, FIG. 3 is an example schematic diagram of material flow in a heating furnace 310 according to an embodiment of this disclosure. A material inlet 3114 and a material outlet 3115 are disposed in the furnace body 311, one end of the first channel 302 communicates with the material inlet 3114, the other end of the first channel 302 communicates with one end of the second channel 303, the other end of the second channel 303 communicates with the material outlet 3115, and both the material inlet 3114 and the material outlet 3115 are located on a same side of the two channels. A material enters the first channel 302 from the material inlet 3114, flows through the second channel 303, and is discharged from the material outlet 3115.

It may be understood that the material inlet 3114 and the material outlet 3115 may be disposed at the furnace bottom 3112 of the furnace body 311, and are spaced apart. In the radial direction H4 of the furnace body 311, the first electrode 312, the material inlet 3114, the second electrode 313, the material outlet 3115, and the sidewall 3111 of the furnace body 311 are successively arranged.

The material in this embodiment of this disclosure enters the first channel 302 from the material inlet 3114 first, is heated up by the electric field formed by the first electrode 312 and the second electrode 313, and then enters the second channel 303 to be gradually cooled down. In this case, the material at a specific temperature in the second channel 303 may also heat the material in the first channel 302, so that heat of the material can be fully used, and utilization of heat is improved.

It should be noted that, in some examples, the material inlet 3114 in this embodiment of this disclosure may alternatively be disposed at one end of the second channel 303, the other end of the second channel 303 communicates with one end of the first channel 302, and the material outlet 3115 is disposed at the other end of the first channel 302. In some other examples, in this embodiment of this disclosure, a port may alternatively be disposed. The material enters the first channel 302 and the second channel 303 from the port, flows in the first channel 302 and the second channel 303, and then is discharged from the port. Specific locations of the inlet and outlet of the material and a flow path are not limited in embodiments of this disclosure.

Still referring to FIG. 1 to FIG. 3, in some examples, the heating furnace 310 in this disclosure is a vertical heating furnace (for example, a vertical continuous heating furnace), and both the material inlet 3114 and the material outlet 3115 are disposed at a bottom of the furnace body 311. In this case, the material enters the first channel 302 from the material inlet 3114 at the bottom, is heated, and then is discharged from the material outlet 3115 by gravity in the second channel 303. A direction of movement of the material is opposite to a direction of gravity. When the material moves in the first channel 302, a temperature of the material gradually increases from the bottom to the top, and a gas generated by heating of the material does not condense in a rising process, thereby avoiding adverse impact of gas condensation on material heating. In addition, when the material falls in the second channel 303 after overflowing, the material is gradually cooled and heats the material that just enters the first channel 302, so that the material heat can be fully utilized.

It may be understood that, in some examples, the material may have an initial speed when entering the first channel 302 from the material inlet 3114 at the bottom, so that the material can move upward along the first channel 302. In some other examples, some devices that can drive the material to move upward from the bottom are further included inside or outside the furnace body 311. A specific manner in which the material moves upward along the first channel 302 is not limited in embodiments of this disclosure.

The heating furnace 310 in this embodiment of this disclosure is of a vertical structure, and uses gravity for discharge. Both the material outlet 3115 and a subsequent cooling system 920 are disposed below the furnace. The heating furnace 310 may be installed at a high place. An occupied area of the heating furnace 310 is small, thereby improving land utilization efficiency. In addition, a feeding apparatus may be placed next to the heating furnace 310, and may continuously feed the material, so that material feeding is more uniform, which is conducive to industrial production, and saves land resources.

Referring to FIG. 1 to FIG. 3 again, the second electrode 313 includes an annular structure, and the second electrode 313 is an annular electrode. By way of example but not limiting, the second electrode 313 is a cylindrical annular electrode or a square annular electrode. At least a part of the first electrode 312 is located in an annular space of the second electrode 313, the annular space is used to form the first channel 302, and the first channel 302 forms enclosed space in the radial direction H4 of the furnace body 311, thereby better facilitating movement of the material.

It may be understood that a first size of the second electrode 313 in the axial direction H5 of the furnace body 311 may be adapted to a second size of the furnace body 311 in the axial direction H5 of the furnace body 311, so that the first size of the second electrode 313 is greater than at least half of the second size. In some examples, the first size of the second electrode 313 may be approximately two-thirds or four-fifths of the second size, or even slightly smaller than the second size. In this case, an axial size of the first channel 302 is larger, and a motion path of the material is longer.

It may be understood that in some examples, the first electrode 312 may be but is not limited to a columnar electrode. For example, the first electrode 312 includes a cylindrical structure or a square columnar structure, so that the first electrode 312 is a cylindrical electrode or a square electrode.

It may be understood that in some examples, one or two of the first electrode 312 and the second electrode 313 may be graphite electrodes. The graphite electrode has low resistivity, which can conduct current efficiently, and has good thermal conductivity, which can rapidly transfer heat, so that a heating effect of the material is better.

The second electrode 313 in this embodiment of this disclosure is an annular electrode, and the first channel 302 forms enclosed space in the radial direction H4, which is more conducive to motion of the material. In addition, when the first electrode 312 is a columnar electrode, a side surface of the first electrode 312 is disposed opposite to an inner surface of the second electrode 313, a relative area between the first electrode 312 and the second electrode 313 is larger, and a coverage area of an electric field formed by the two is wider, so that more materials can be heated.

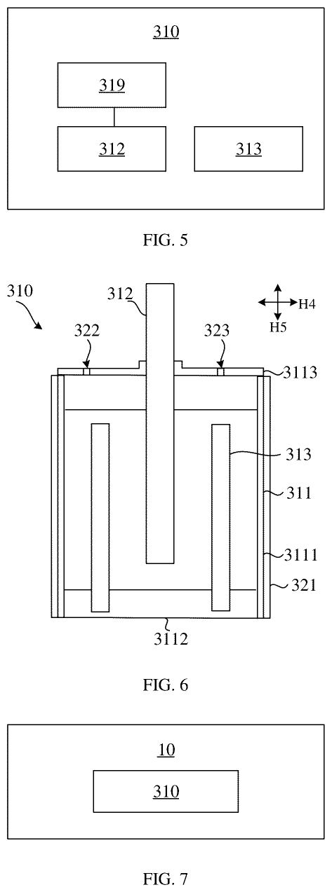

With reference to FIG. 1 to FIG. 3, and further referring to FIG. 4 and FIG. 5, FIG. 4 is an example schematic diagram of another structure of the heating furnace 310 according to an embodiment of this disclosure, and FIG. 5 is an example schematic diagram of still another structure of the heating furnace 310 according to an embodiment of this disclosure. In this embodiment of this disclosure, an overlapping length of the first electrode 312 and the second electrode 313 in the axial direction H5 of the furnace body 311 may be adjusted.

It may be understood that in some examples, the heating furnace 310 includes an adjustment unit 319, and the adjustment unit 319 is configured to adjust the overlapping length of the first electrode 312 and the second electrode 313 in the axial direction H5 of the furnace body 311. For example, the adjustment unit 319 is configured to drive at least one of the first electrode 312 and the second electrode 313 to move in the axial direction H5 of the furnace body 311.

For example, the adjustment unit 319 may be connected to the first electrode 312. The adjustment unit 319 is configured to drive the first electrode 312 to move in the axial direction H5 of the furnace body 311, and the adjustment unit 319 may adjust a length that is of the first electrode 312 and that is in the annular space of the second electrode 313, to adjust the overlapping length of the first electrode 312 and the second electrode 313 in the axial direction H5 of the furnace body 311.

For another example, the adjustment unit 319 is connected to the second electrode 313, and the adjustment unit 319 is configured to drive the second electrode 313 to move in the axial direction H5 of the furnace body 311, to adjust the overlapping length of the first electrode 312 and the second electrode 313 in the axial direction H5 of the furnace body 311.

For still another example, the adjustment unit 319 may alternatively be connected to both the first electrode 312 and the second electrode 313, and drive the first electrode 312 and the second electrode 313 to move relative to each other, to adjust the overlapping length of the first electrode 312 and the second electrode 313 in the axial direction H5 of the furnace body 311.

It may be understood that the adjustment unit 319 may be but is not limited to a drive motor, and the drive motor is connected to at least one of the first electrode 312 and the second electrode 313, to adjust the overlapping length of the two electrodes in the axial direction H5 of the furnace body 311. Certainly, the adjustment unit 319 may alternatively be an operator, and the user may manually drive at least one of the first electrode 312 and the second electrode 313 to move, to adjust the overlapping length of the two electrodes in the axial direction H5 of the furnace body 311. A specific structure of the adjustment unit 319 is not limited in embodiments of this disclosure.

It may be understood that when the overlapping length of the first electrode 312 and the second electrode 313 in the axial direction H5 of the furnace body 311 is different, the material located in the first channel 302 has a different resistance in the electric field formed by the first electrode 312 and the second electrode 313. For example, comparing FIG. 1 with FIG. 4, the first electrode 312 and the second electrode 313 shown in FIG. 1 have a first overlapping length in the axial direction H5 of the furnace body 311, and the material has a first resistance value when being located in the first channel 302. The first electrode 312 and the second electrode 313 shown in FIG. 4 have a second overlapping length in the axial direction H5 of the furnace body 311, and a same material has a second resistance value when being located on the first channel 302. When the second overlapping length shown in FIG. 4 is greater than the first overlapping length shown in FIG. 1, the second resistance value of the material is less than the first resistance value. When the second overlapping length is less than the first overlapping length, the second resistance value of the material is greater than the first resistance value in this case.

In this embodiment of this disclosure, the adjustment unit 319 adjusts the overlapping length of the first electrode 312 and the second electrode 313 in the axial direction H5 of the furnace body 311, to adjust the resistance value of the material in the first channel 302 between the first electrode 312 and the second electrode 313, so that the material can better generate heat and be heated at a present resistance value. Further, the solution of this disclosure can adjust resistance values of different materials, and can adapt to more different materials, so that the heating furnace 310 of this disclosure has better adaptability.

It should be noted that the overlapping length between the first electrode 312 and the second electrode 313 in this disclosure may alternatively be fixed. In this case, the heating furnace 310 may not include the adjustment unit 319. A specific structure of the heating furnace 310 is not limited by the specifically described embodiments of this disclosure.

Referring to FIG. 1 to FIG. 4 again, the heating furnace 310 in this embodiment of this disclosure further includes a clamping member 314, and the clamping member 314 is configured to limit the first electrode 312 through clamping.

It may be understood that the first electrode 312 includes a first part 3121 and a second part 3122, the first part 3121 is located in the accommodation space 301 inside the furnace body 311, the second part 3122 is located outside the furnace body 311. For example, a through hole is disposed on the furnace cover 3113, the second part 3122 of the first electrode 312 passes through the through hole and extends out of the furnace cover 3113, and the clamping member 314 is configured to clamp the second part 3122, to fix the first electrode 312.

It may be understood that the clamping member 314 may further release limitation on the first electrode 312, so that the first electrode 312 moves in the axial direction H5 of the furnace body 311. In this case, the first electrode 312 may slide relative to the clamping member 314. For example, the clamping member 314 includes two clamping arms that can be opened and closed. When the two clamping arms are opened, the first electrode 312 can slide relative to the clamping member 314, and further, the adjustment unit 319 can adjust the overlapping length of the first electrode 312 and the second electrode 313 in the axial direction H5 of the furnace body 311. When the two clamping arms are closed, the first electrode 312 is fixed relative to the furnace body 311, and the first electrode 312 and the second electrode 313 can be energized to form the electric field to heat the material.

It may be understood that in some examples, as shown in FIG. 1 to FIG. 4, the heating furnace 310 further includes an insulating member 315. The insulating member 315 is a non-conductive structure, and the insulating member 315 is located between the clamping member 314 and the furnace cover 3113, so as to avoid a short circuit because the clamped first electrode 312 contacts the furnace cover 3113 or the furnace body 311. The insulating member 315 in this disclosure improves safety of the heating furnace 310.

The clamping member 314 in this embodiment of this disclosure can fix the first electrode 312 through clamping, and enables the first electrode 312 to adjust the overlapping length between the first electrode 312 and the second electrode 313. The clamping member 314 makes adjustment of the first electrode 312 more flexible.

Referring to FIG. 1 to FIG. 4 again, the heating furnace 310 further includes a power supply apparatus 318. The power supply apparatus 318 is electrically connected to the first electrode 312 through a first power supply conductor 316, and is electrically connected to the second electrode 313 through a second power supply conductor 317. The power supply apparatus 318 is configured to supply power to the first electrode 312 and the second electrode 313.

It may be understood that the clamping member 314 may be a conductive member, and the first power supply conductor 316 may be connected to the clamping member 314 to implement an electrical connection. When the clamping member 314 fixes the first electrode 312 through clamping, the power supply apparatus 318, the first power supply conductor 316, the clamping member 314, the first electrode 312, the second electrode 313, and the second power supply conductor 317 form a current loop, and the material is conducted between the first electrode 312 and the second electrode 313 to generate heat spontaneously, thereby implementing heating of the material.

It may be understood that the power supply apparatus 318 may be but is not limited to a power supply rectifier device. The power supply apparatus 318 may adjust a value of a current or a voltage to adjust heating power of the electric field formed by the first electrode 312 and the second electrode 313.

The power supply apparatus 318 in this embodiment of this disclosure can stably heat the material by controlling the heating power. In addition, the power supply apparatus 318 may be disposed near the furnace body 311, so as to help reduce a quantity of used copper-aluminum bars, reduce costs, reduce a power supply energy loss, and improve energy utilization.

FIG. 6 is an example schematic diagram of yet another structure of the heating furnace 310 according to an embodiment of this disclosure. The heating furnace 310 further includes a thermal insulation structure 321, and the thermal insulation structure 321 is disposed around an outer surface of the sidewall 3111 of the furnace body 311. The thermal insulation structure 321 can reduce a temperature outward diffusion rate of the furnace body 311.

It may be understood that the thermal insulation structure 321 may be but is not limited to a thermal insulation coating, a fireproof fiber material, a mineral cotton thermal insulation material, a calcium silicate thermal insulation material, and a diatomite thermal insulation material.

In this embodiment of this disclosure, the thermal insulation structure 321 is disposed on an outer side of the furnace body 311. After a temperature of the furnace body 311 rises, the furnace body 311 is not frequently heated or cooled, thereby reducing a heat loss. In addition, unlike an Acheson furnace that requires charge and discharge for each furnace, in this disclosure, frequent charge and discharge of auxiliary materials are reduced.

In some examples, the heating furnace 310 further includes a gas inlet 322 and a gas outlet 323. The gas inlet 322 is configured to introduce a shielding gas, and the gas outlet 323 is configured to discharge the shielding gas, a volatile gas generated in a heating process, and the like. Both the gas inlet 322 and the gas outlet 323 communicate with the accommodation space 301.

It may be understood that the gas inlet 322 and the gas outlet 323 may be disposed on the sidewall 3111, the furnace bottom 3112, or the furnace cover 3113 of the furnace body 311, and the shielding gas enters the furnace body 311 from the gas inlet 322. Because the material carries some air when entering the furnace body 311, if protection is not provided, oxidation and ignition easily occur when the material contacts the air at a high temperature, which may decrease a material yield, and affect parameters of the material to make the parameters unqualified. The filled shielding gas in this disclosure dilutes an air concentration to avoid high temperature oxidation and ignition of the material.

It may be understood that the shielding gas may be but is not limited to a gas such as nitrogen and argon. The gas inlet 322 of the heating furnace 310 communicates with a shielding gas apparatus to receive the shielding gas transferred by the shielding gas apparatus.

In the heating furnace 310 in this embodiment of this disclosure, the shielding gas such as nitrogen and argon is introduced in a heating process, which can reduce consumption of the material, increase a yield, and improve material quality.

Based on the foregoing structure of the heating furnace 310, an embodiment of this disclosure further provides a production system 10. FIG. 7 is an example schematic diagram of a structure of the production system 10 according to an embodiment of this disclosure. The production system 10 includes a heating furnace 310, and the heating furnace 310 can prepare a negative electrode material of a battery. The heating furnace 310 is the heating furnace 310 in any one of the foregoing embodiments. For example, the heating furnace 310 includes a furnace body 311, a first electrode 312, and a second electrode 313. The furnace body 311 is provided with an accommodation space 301. The first electrode 312 and the first electrode 313 have opposite polarities, at least a part of the first electrode 312 is disposed in the accommodation space 301, and the second electrode 313 is disposed in the accommodation space 301. In a radial direction H4 of the furnace body 311, the first electrode 312, the second electrode 313, and a sidewall 3111 of the furnace body 311 are successively arranged at intervals, so that a first channel 302 is formed between the first electrode 312 and the second electrode 313, and a second channel 303 is formed between the second electrode 313 and the sidewall 3111 of the furnace body 311. The second channel 303 and the first channel 302 extend in an axial direction H5 of the furnace body 311 and communicate with each other to form a material channel.

It may be understood that, in some examples, a material inlet 3114 and a material outlet 3115 are disposed in the furnace body 311, one end of the first channel 302 communicates with the material inlet 3114, the other end of the first channel 302 communicates with one end of the second channel 303, the other end of the second channel 303 communicates with the material outlet 3115, and both the material inlet 3114 and the material outlet 3115 are located on a same side of the two channels. A material enters the first channel 302 from the material inlet 3114, flows through the second channel 303, and is discharged from the material outlet 3115.

It may be understood that in some examples, the heating furnace 310 is a vertical heating furnace (for example, a vertical continuous heating furnace), and the material inlet 3114 and the material outlet 3115 may be disposed at a furnace bottom 3112 of the furnace body 311.

It may be understood that in some examples, the heating furnace 310 includes an adjustment unit 319, and the adjustment unit 319 is configured to adjust an overlapping length of the first electrode 312 and the second electrode 313 in the axial direction H5 of the furnace body 311. For example, the adjustment unit 319 is configured to drive at least one of the first electrode 312 and the second electrode 313 to move in the axial direction H5 of the furnace body 311.

It may be understood that the heating furnace 310 in this embodiment of this disclosure may be but is not limited to a graphitization apparatus (for example, a vertical continuous graphitization apparatus) and a high temperature carbonization apparatus (for example, a vertical continuous high temperature carbonization apparatus), and the heating furnace 310 may, but not limited to, implement a graphitization process and a high temperature carbonization process of the negative electrode material of the battery.

It should be noted that for the heating furnace 310 of the production system 10 in this embodiment of this disclosure, descriptions of any one of the foregoing embodiments may be referenced and/or combined. Details are not described herein again. In addition to the heating furnace 310, the production system 10 in this disclosure may include but is not limited to a structure such as a continuous granulation kettle and a precarbonization rotary kiln. A specific structure of the production system 10 is not limited in the specific embodiments explicitly described in this disclosure.

Based on the foregoing structure, an embodiment of this disclosure further provides a production system 10, where the production system 10 is configured to prepare a negative electrode material of a lithium battery.

In the field of lithium-ion batteries, a production process of a graphite negative electrode material of the lithium-ion battery mainly includes grinding of raw materials, granulation, precarbonization, graphitization, high temperature carbonization, and finishing a product. In the related technology, the granulation process uses a vertical kettle or a horizontal kettle, which performs intermittent production, and has a low yield. The precarbonization process uses a tunnel kiln, which occupies a large area. A graphitization device is mainly an Acheson heating furnace, which is of an open rectangular structure, is usually tens of meters long, and occupies a large area. A charge device, a heating device, a discharge device, and other auxiliary devices are also large-scale devices, which have a low automation level and require high investment, more workers, and high labor intensity. In a production workshop of the negative electrode material in the related technology, the vertical or horizontal kettle, the tunnel kiln, and the Acheson heating furnace occupy a large area, require high investment of the factory, and increase production costs.

To resolve the foregoing technical problems, embodiments in this disclosure provide a production system 10 and a battery preparation system 20. The following describes the production system 10 and the battery preparation system 20 in detail with reference to specific embodiments. It should be noted that embodiments of this disclosure may be presented in various forms. Some examples are described below.

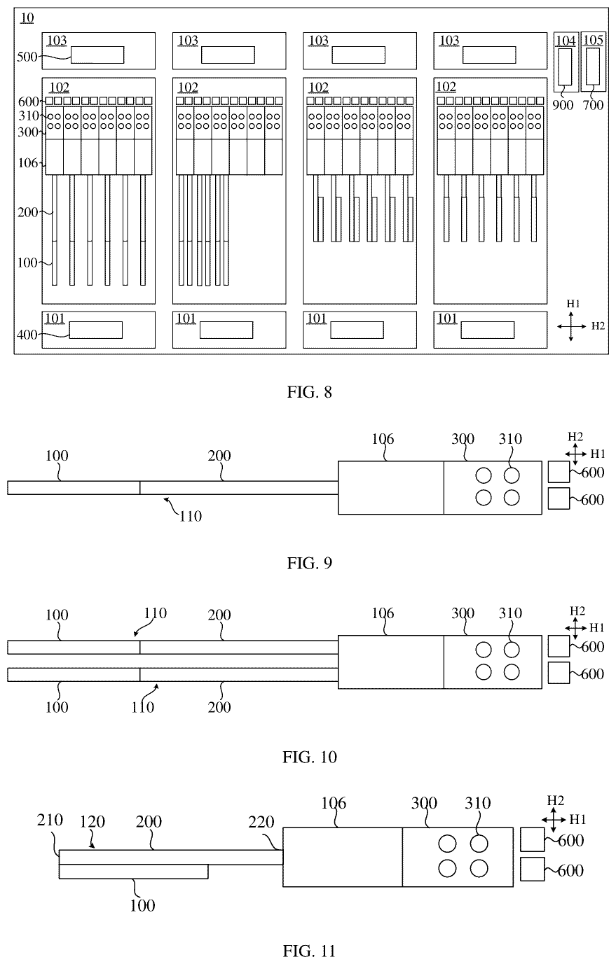

FIG. 8 is an example schematic diagram of a structure of the production system 10 according to an embodiment of this disclosure. The production system 10 of this disclosure is configured to prepare a negative electrode material of a lithium battery. The production system 10 includes at least a granulation unit 100, a precarbonization unit 200, and a plurality of heating units 300. The granulation unit 100, the precarbonization unit 200, and the heating unit 300 are successively connected. Both the granulation unit 100 and the precarbonization unit 200 extend and are disposed in a first direction H1, the plurality of heating units 300 are arranged and disposed in a second direction H2, and the second direction H2 is different from the first direction H1. In the first direction H1, the granulation unit 100 and the precarbonization unit 200 are disposed on a same side of the plurality of heating units 300.

It may be understood that the granulation unit 100 is configured to perform a granulation process on a prefabricated material to obtain a coating material. The prefabricated material is obtained by performing a pretreatment process on a negative electrode raw material. The so-called granulation process refers to mixing a pretreated prefabricated material (for example, a pulverized and sieved negative electrode material powder) with a binder, an additive, or the like, and bonding and agglomerating powder particles with each other by using the granulation unit 100, to form secondary particles with specific strength and granularity distribution and form a coating material. The granulation process can improve compacted density and structural stability of the material, improve conductivity of the material, improve reaction activity of the material, and optimize a surface feature of the material. The granulation unit 100 may include but is not limited to a continuous granulation kettle, and the continuous granulation kettle can continuously perform the granulation process on the prefabricated material.

It may be understood that the precarbonization unit 200 is connected to the granulation unit 100, and is configured to perform a precarbonization process on the coating material to obtain a precarbonized material. The so-called precarbonization process refers to performing preliminary carbonization processing on the granulated coating material, for example, placing the coating material in the precarbonization unit 200 and gradually heating the coating material to a specific temperature under protection of an inert gas (such as nitrogen and argon) and maintaining for a specific time, so that an organic component in the material is pyrolyzed to generate a carbon skeleton structure and obtain the precarbonized material. The precarbonization unit 200 may include but is not limited to a precarbonization rotary kiln. The precarbonization rotary kiln can continuously perform the precarbonization process on the coating material.

It may be understood that the heating unit 300 is connected to the precarbonization unit 200, and is configured to perform a graphitization process and/or a high temperature carbonization process on the precarbonization unit 200, and obtain a graphitized material or a high temperature carbonized material. The so-called graphitization process refers to a high temperature heat treatment procedure in which a precarbonized material of amorphous turbostratic structure carbon is converted into a three-dimensional ordered graphite crystalline structure under a high temperature condition (for example, about 2,500 degrees Celsius). After the graphitization process, conductivity, structural stability, and reaction activity of the graphitized material are further improved. The so-called high temperature carbonization process refers to a procedure in which a carbon material is further carbonized at a high temperature (for example, about 1,500 degrees Celsius) to further increase a degree of carbonization and improve structural stability. The heating unit 300 may include but is not limited to a vertical continuous heating furnace, for example, a vertical continuous graphitization apparatus and a vertical continuous high temperature carbonization apparatus.

It may be understood that the first direction H1 is a length direction of the granulation unit 100 and the precarbonization unit 200, and both the granulation unit 100 and the precarbonization unit 200 extend in the first direction H1. The second direction H2 is an arrangement direction of the plurality of heating units 300, and the plurality of heating units 300 are arranged and disposed in the second direction H2. The second direction H2 may be perpendicular to the first direction H1. For example, from a perspective of a production workshop, the second direction H2 may be a length direction of the production workshop, and the first direction H1 may be a width direction of the production workshop. Regions occupied by the granulation unit 100 and the precarbonization unit 200 and regions occupied by the plurality of heating units 300 are arranged in the first direction H1, so that the granulation unit 100 and the precarbonization unit 200 are disposed on a same side of the plurality of heating units 300.

In the production system 10 in this embodiment of this disclosure, both the granulation unit 100 and the precarbonization unit 200 are disposed in the first direction H1, and the plurality of heating units 300 are arranged and disposed in the second direction H2. The production system 10 is not easy to occupy large layout space in the first direction H1 or the second direction H2. In addition, the granulation unit 100 and the precarbonization unit 200 are disposed on a same side of the plurality of heating units 300, and the granulation unit 100 and the precarbonization unit 200 properly use a region on one side of the plurality of heating units 300. Compared with a solution in which the granulation unit 100 and the precarbonization unit 200 are separately disposed on different sides of the plurality of heating units 300, in the solution of this disclosure, the production system 10 occupies less layout space. Based on this, in this disclosure, an arrangement manner of the granulation unit 100, the precarbonization unit 200, and the plurality of heating units 300 is designed to reduce layout space occupied by the production system 10, thereby reducing factory investment costs and production costs. In addition, when the granulation unit 100 includes a continuous granulation kettle, the precarbonization unit 200 includes a precarbonization rotary kiln, and the heating unit 300 includes a vertical continuous heating furnace, the production system 10 in this disclosure can perform integrated continuous production, which has a high degree of automation, greatly reduces energy consumption, and further reduces production costs.

With reference to FIG. 8, referring to FIG. 9 and FIG. 10, FIG. 9 is an example schematic diagram of a first layout of the production system 10 according to an embodiment of this disclosure, and FIG. 10 is an example schematic diagram of a second layout of the production system 10 according to an embodiment of this disclosure. The production system 10 may include a plurality of granulation units 100 and a plurality of precarbonization units 200. The plurality of granulation units 100 and the plurality of precarbonization units 200 are disposed in a one-to-one correspondence. Each granulation unit 100 and one precarbonization unit 200 are arranged in the first direction H1 and connected to form a first entirety 110.

It may be understood that, as shown in FIG. 8 and FIG. 9, the production system 10 includes a plurality of first entireties 110, each first entirety 110 is connected to one heating unit 300, and one granulation unit 100, one precarbonization unit 200, and one heating unit 300 form an in-line connection. In this case, in the second direction H2, adjacent first entireties 110 are spaced apart from each other and have a large spacer region, so that mutual interference between the plurality of first entireties 110 during operation can be avoided.

It may be understood that, as shown in FIG. 8 and FIG. 10, at least two (including two or more) first entireties 110 are connected to one heating unit 300. For example, two first entireties 110 are arranged in the second direction H2, the two first entireties 110 are disposed in parallel in the first direction H1, and the two first entireties 110 are connected to a same heating unit 300. In this case, a spacing between two adjacent first entirety 110 is small, overall space occupied by the plurality of first entirety 110 is small, and more remaining space in the region on the side of the heating unit 300 can be used to dispose another device, thereby improving space utilization of the workshop.

In the first entirety 110 in this embodiment of this disclosure, the granulation unit 100 and the precarbonization unit 200 form an in-line connection, the granulation unit 100 and the precarbonization unit 200 are arranged more regularly, and more space can be reserved between adjacent first entireties 110 for transport setup and for personnel to walk around.

With reference to FIG. 8, and further referring to FIG. 11, FIG. 11 is an example schematic diagram of a third layout of the production system 10 according to an embodiment of this disclosure. Each granulation unit 100 and one precarbonization unit 200 are arranged in the second direction H2 and connected to form a second entirety 120. As shown in FIG. 11, each second entirety 120 is connected to one heating unit 300. Certainly, in another embodiment, at least two second entirety 120 may alternatively be disposed to be connected to one heating unit 300.

It may be understood that, as shown in FIG. 8 and FIG. 11, in one second entirety 120, the granulation unit 100 and the precarbonization unit 200 are arranged in the second direction H2 and connected. In this case, space occupied by the granulation unit 100 and the precarbonization unit 200 in the first direction H1 is small, and more remaining space in the region on the side of the heating unit 300 can be used to dispose another device, thereby improving space utilization of the workshop.

It may be understood that, as shown in FIG. 11, considering that a length of the precarbonization rotary kiln of the precarbonization unit 200 in the first direction H1 is long, and a length of the continuous granulation kettle of the granulation unit 100 in the first direction H1 is short, in some examples, each precarbonization unit 200 includes a first end 210 and a second end 220 disposed opposite to each other in the first direction H1, and the second end 220 is located between the first end 210 and the heating unit 300. In one second entirety 120, one end of the granulation unit 100 is flush with the first end 210, and a projection of the other end of the granulation unit 100 on the precarbonization unit 200 is located between the first end 210 and the second end 220. In this case, the granulation unit 100 and the precarbonization unit 200 form a U-shaped connection. In the first direction H1, there is a specific gap between the short granulation unit 100 and the heating unit 300, and the gap is more convenient for transport setup and for personnel to walk around.

It should be noted that, the granulation unit 100 may be flush with the second end 220 of the precarbonization unit 200, or the granulation unit 100 may not be flush with both ends of the precarbonization unit 200. This is not limited in embodiments of this disclosure.

In the first entirety 110 in this embodiment of this disclosure, the granulation unit 100 and the precarbonization unit 200 form a U-shaped connection, and space occupied by the first entirety 110 in the first direction H1 is small, thereby further reducing factory investment costs and production costs.

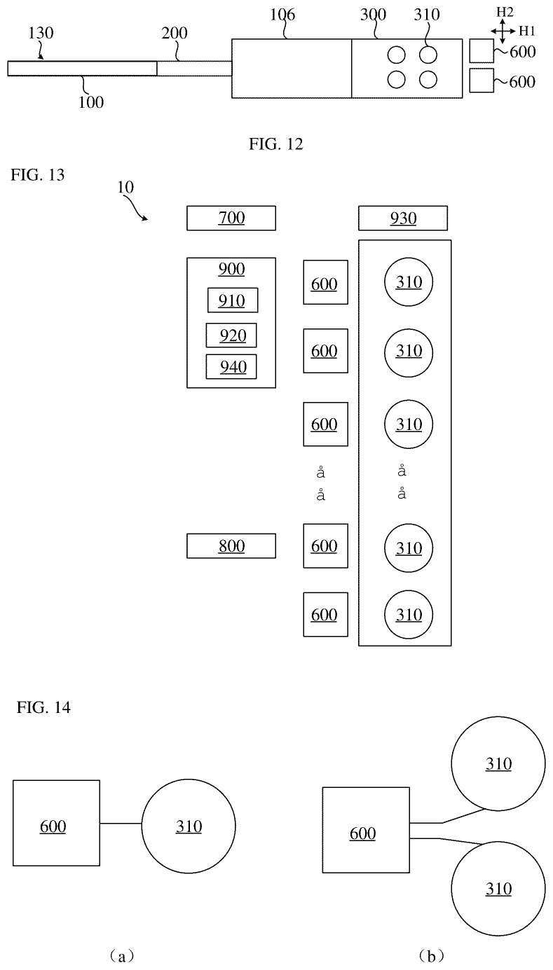

With reference to FIG. 8, referring to FIG. 12, FIG. 12 is an example schematic diagram of a fourth layout of the production system 10 according to an embodiment of this disclosure. One granulation unit 100 and one precarbonization unit 200 are arranged in a third direction and connected to form a third entirety 130, and each third entirety 130 is connected to one heating unit 300. At least two third entireties 130 are connected to one heating unit 300.

It may be understood that the third direction is different from the first direction H1 and the second direction H2. For example, the first direction H1 may be a width direction of a production workshop in which the entire production system 10 is located, the second direction H2 is a length direction of the production workshop, the third direction is a height direction of the production workshop, and the third direction is a direction perpendicular to the ground. In this case, in one third entirety 130, the granulation unit 100 is located between the precarbonization unit 200 and the ground. In this case, a first projection of the granulation unit 100 on the ground is located in a second projection of the precarbonization unit 200 on the ground, and the second projection covers the first projection.

In the third entirety 130 in this embodiment of this disclosure, the granulation unit 100 and the precarbonization unit 200 are stacked in the third direction and disposed at different heights. Space occupied by the third entirety 130 in the first direction H1 is small, and a spacing between adjacent third entireties 130 is also large, which can reduce factory investment costs and production costs, and avoid mutual interference between a plurality of first entirety 110.

It should be noted that the foregoing descriptions are merely several exemplary arrangement manners of the granulation unit 100 and the precarbonization unit 200, and the granulation unit 100 and the precarbonization unit 200 may alternatively have another arrangement manner. This is not limited in embodiments of this disclosure. In addition, it should be noted that FIG. 8 is merely used to indicate a layout of the production system 10 of this disclosure, and is not used to limit the production system 10. For example, in the production system 10 of this disclosure, all granulation units 100 and precarbonization units 200 may use an in-line connection, a U-shaped connection, or a high-low connection. Alternatively, a part of granulation units 100 and precarbonization units 200 uses one connection manner, and another part of granulation units 100 and precarbonization units 200 uses another connection manner.

Referring to FIG. 8 again, the production system 10 in this embodiment of this disclosure further includes a pretreatment unit 400 and a finished product preparation unit 500. In the first direction H1, the pretreatment unit 400 is disposed on a same side of the plurality of heating units 300 as the granulation unit 100 and the precarbonization unit 200, and the finished product preparation unit 500 is disposed on an opposite side of the heating unit 300. For example, the plurality of heating units 300 include a first side and a second side in the first direction H1, the pretreatment unit 400, the granulation unit 100, and the precarbonization unit 200 are disposed on the first side, and the finished product preparation unit 500 is disposed on the second side.

It may be understood that the pretreatment unit 400 is connected to the granulation unit 100. The pretreatment unit 400 is configured to perform the pretreatment process on the negative electrode raw material to obtain the foregoing prefabricated material. The so-called pretreatment process refers to a procedure in which a plurality of processes such as pulverization, sieving, drying, and mixing are performed on the negative electrode raw material in the pretreatment unit 400 to form the prefabricated material. The pretreatment unit 400 may be a single apparatus and implement the plurality of processes, and the pretreatment unit 400 may alternatively include a plurality of subunits to separately implement the plurality of processes.

It may be understood that the finished product preparation unit 500 is connected to the plurality of heating units 300. The finished product preparation unit 500 is configured to perform a finished product fabrication process on the graphitized and/or high temperature carbonized material. The so-called finished product fabrication process refers to performing a plurality of processes such as pulverization, sieving, surface treatment, inspection of the finished product, and packaging on the graphitized and/or high temperature carbonized material to form a finished product of the negative electrode material of the lithium battery. The finished product preparation unit 500 may be a single apparatus and implement the plurality of processes, and the finished product preparation unit 500 may alternatively include a plurality of subunits to separately implement the plurality of processes.

It may be understood that the production system 10 in this disclosure includes a first workshop 101, a second workshop 102, and a third workshop 103. The pretreatment unit 400 is disposed in the first workshop 101, the granulation unit 100, the precarbonization unit 200, and the heating unit 300 are jointly disposed in the second workshop 102, and the finished product preparation unit 500 is disposed in the third workshop 103. Therefore, one first workshop 101, one second workshop 102, and one third workshop 103 are arranged in the first direction H1. The production system 10 may include a plurality of first workshops 101 to third workshops 103 that have equal quantities and are matched correspondingly.

It should be noted that the production system 10 may further include a fourth workshop 104 and a fifth workshop 105. The fourth workshop 104 is configured to set a public facility such as a shielding gas facility and a circulating water facility, and the fifth workshop 105 is configured to set a power distribution system 700 such as a transformer substation. A specific layout of the production system 10 is not limited in embodiments of this disclosure.

In this embodiment of this disclosure, the pretreatment unit 400, the granulation unit 100, and the precarbonization unit 200 are disposed on the first side of the plurality of heating units 300, and the finished product preparation unit 500 is disposed on the second side. On the one hand, the pretreatment unit 400 is close to the granulation unit 100 and the precarbonization unit 200, which shortens a distance for the prefabricated material produced by the pretreatment unit 400 to enter the granulation unit 100, and reduces transport costs of the prefabricated material. On the other hand, the finished product preparation unit 500 is disposed on the second side, and not only space occupied by the finished product preparation unit 500 is reduced, but also physical isolation is implemented between the finished product preparation unit 500 and the pretreatment unit 400, the granulation unit 100, and the precarbonization unit 200 in space, so as to avoid contamination such as gas and dust generated when the foregoing units operate on the finished product of the negative electrode material prepared by the finished product preparation unit 500, thereby ensuring quality of the finished product of the negative electrode material.

Referring to FIG. 8 to FIG. 12 again, each heating unit 300 includes at least one heating furnace 310. The plurality of heating furnaces 310 may be of a vertical structure, and the plurality of heating furnaces 310 are arranged in parallel. For example, in FIG. 8 to FIG. 12, each heating unit 300 includes four heating furnaces 310, and the four heating furnaces 310 are distributed by a 2×2 matrix. An entirety formed by connecting one granulation unit 100 and one precarbonization unit 200 is connected to the four heating furnaces 310. Because the heating furnace 310 performs the graphitization process and/or the high temperature carbonization process for a long time, and the granulation unit 100 and the precarbonization unit 200 perform corresponding processes for a short time, one granulation unit 100 and one precarbonization unit 200 in this disclosure match a plurality of heating furnaces 310, thereby greatly improving production efficiency of the production system 10.

Referring to FIG. 8 to FIG. 12 again, when one heating unit 300 includes a plurality of heating furnaces 310, the plurality of heating furnaces 310 may perform a same graphitization process or high temperature carbonization process, or two heating furnaces 310 in the plurality of heating furnaces 310 respectively perform the graphitization process and the high temperature carbonization process. For example, in the four heating furnaces 310 distributed by a 2×2 matrix, in the two heating furnaces 310 arranged in the first direction H1, one heating furnace 310 close to the precarbonization unit 200 performs the graphitization process and is a graphitization apparatus (for example, a vertical graphitization apparatus or a vertical continuous graphitization apparatus), and one heating furnace 310 close to the rectifier transformer unit 600 performs the high temperature carbonization process and is a high temperature carbonization apparatus (for example, a vertical high temperature carbonization apparatus or a vertical continuous high temperature carbonization apparatus). The granulation unit 100, the precarbonization unit 200, the heating furnace 310 performing the graphitization process, and the heating furnace 310 performing the high temperature carbonization process are connected successively in the first direction H1. In this disclosure, a roller kiln performing the high temperature carbonization process in the related technology is replaced with the heating furnace 310 performing the high temperature carbonization process. An occupied area of the heating furnace 310 in this disclosure is much smaller than that of the roller kiln, further reducing the layout space occupied by the production system 10. In addition, in the four heating furnaces 310 that is distributed by a 2×2 matrix and that is included in one heating unit 300, there are two combinations of the graphitization apparatus and the high temperature carbonization apparatus. One granulation unit 100 and one precarbonization unit 200 are connected to the two combinations, which greatly improves production efficiency of the production system 10.

It should be noted that the word “a plurality of” in embodiments of this disclosure generally refers to two or more unless specified otherwise.

Referring to FIG. 8 to FIG. 12 again, the production system 10 may further include a plurality of material processing transit zones 106, and each material processing transit zone 106 is disposed in one second workshop 102. For example, an entirety formed by connecting one granulation unit 100 and one precarbonization unit 200 corresponds to one material processing transit zone 106 and corresponds to one heating unit 300. In this case, the material processing transit zone 106 can temporarily store the precarbonized material prepared by the precarbonization unit 200, to perform feed allocation based on a progress of each heating furnace 310 in the heating unit 300.

Referring to FIG. 8 to FIG. 12 again, and referring to FIG. 13, FIG. 13 is a schematic diagram of a connection of the heating unit 300 of the production system 10 according to an embodiment of this disclosure. The production system 10 in this embodiment of this disclosure further includes at least one rectifier transformer unit 600.

It may be understood that the rectifier transformer unit 600 is configured to drop a high voltage to a low voltage, and after rectification, convert an alternating current into a direct current. In some examples, the rectifier transformer unit 600 includes a rectifier transformer and a rectifier. In some other examples, the rectifier transformer unit 600 is a structure integrating a rectifier transformer and a rectifier function. The rectifier transformer unit 600 is electrically connected to the heating furnace 310, for example, is connected to two electrodes of the heating furnace 310. The rectifier transformer unit 600 has a function of adjusting a voltage of the heating furnace 310, to adjust a voltage of an actual output direct current through an on-load tap changer, a controllable rectifier, and the like, so as to adjust heating power of the heating furnace 310.

It may be understood that, with reference to FIG. 13, referring to FIG. 14, FIG. 14 is an example schematic diagram of an electrical connection of the heating furnace 310 of the production system 10 according to an embodiment of this disclosure. As shown in FIG. 13 and (a) in FIG. 14, a plurality of heating furnaces 310 are disposed in a one-to-one correspondence with a plurality of rectifier transformer units 600, so that each heating furnace 310 is electrically connected to one rectifier transformer unit 600, and the rectifier transformer unit 600 can adjust a voltage of one heating furnace 310 electrically connected thereto. As shown in (b) in FIG. 14, at least two heating furnaces 310 are electrically connected to one rectifier transformer unit 600. One rectifier transformer unit 600 may have two sets of low-voltage windings (for example, two sets of low-voltage windings of different phases), and the two sets of low-voltage windings are connected to two heating furnaces 310, respectively. During operation, the rectifier transformer unit 600 adjusts the voltage through a controllable rectifier, so as to control heating power of the heating furnace 310.

It may be understood that, in some examples, when the production system 10 includes a plurality of rectifier transformer units 600, phases of signals transmitted by adjacent rectifier transformer units 600 are different. Because there are harmonics when a rectifier system operates, which affects power supply quality of a power distribution system 700 such as a power grid, and interferes with another electric device, a plurality of rectifier transformer units 600 of the rectifier system perform phase shift matching to form a multi-pulse rectifier. For example, in two adjacent rectifier transformer units 600, one rectifier transformer unit 600 is 6-pulse output, and the other rectifier transformer unit 600 is 12-pulse output, 18-pulse output, or 24-pulse output. In this case, two adjacent rectifier transformer units 600 cancel a part of harmonics, and can meet a power supply quality requirement.

In the production system 10 in this embodiment of this disclosure, the rectifier transformer unit 600 can control heating power of the heating furnace 310, thereby improving quality controllability of the heating furnace 310. In addition, in the production system 10 of this disclosure, the granulation unit 100, the precarbonization unit 200, and the heating unit 300 are disposed in a cluster, and one rectifier transformer unit 600 may be electrically connected to a plurality of heating furnaces 310, thereby reducing investment and costs of the rectifier transformer unit 600. In addition, the plurality of rectifier transformer units 600 perform phase shift matching, which reduces harmonic interference generated in the power distribution system 700, and can also reduce investment of the power distribution system 700.

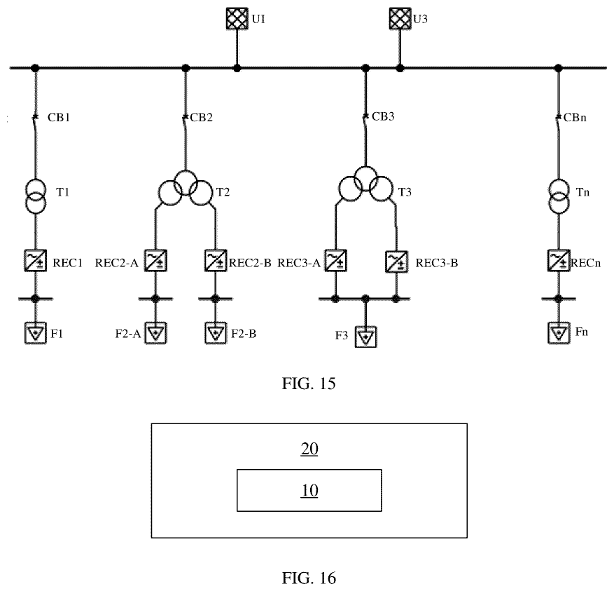

Referring to FIG. 13 again, and referring to FIG. 15, FIG. 15 is an example schematic diagram of an electrical connection of the power distribution system 700 of the production system 10 according to an embodiment of this disclosure. The production system 10 in this embodiment of this disclosure further includes the power distribution system 700. The power distribution system 700 is electrically connected to the rectifier transformer unit 600. The power distribution system 700 is configured to supply power to the heating furnace 310.

It may be understood that, in some examples, the power distribution system 700, one rectifier transformer unit 600, and one heating furnace 310 are connected successively to form a first power supply path. For example, in the example of FIG. 15, an upper power grid U1 or U3 is the power distribution system 700. High-voltage switches CB1 to CBn are switch modules. The rectifier transformer unit 600 includes a rectifier transformer and a rectifier, the rectifier transformer includes T1 to Tn shown in FIG. 15, and the rectifier includes REC1 to RECn shown in FIG. 15. Loads F1 to Fn are a plurality of heating furnaces 310. In the first power supply path shown in FIG. 15, a power supply is connected from the upper power grid U1 or U3, and power transmission and power cut of the rectifier transformer T1 are controlled through the high-voltage switch CB1. The rectifier transformer Tl has an on-load tap changer, which can adjust an output voltage. The rectifier REC1 is connected to the rectifier transformer T1, outputs a direct current, and is connected to the load F1 through a direct current bus. The rectifier transformer T1 may be a diode direct rectifier or a controllable rectifier.

It may be understood that, in some examples, the rectifier transformer unit 600 includes a plurality of output windings, and the power distribution system 700, one output winding, and one heating furnace 310 are connected successively to form a second power supply path. For example, in the example of FIG. 15, a power supply is connected from the upper power grid U1 or U3, and power transmission and power cut of the rectifier transformer T2 are controlled through the high-voltage switch CB2. The rectifier transformer has an on-load tap changer, which can adjust an output voltage. The rectifier transformer has two sets, three sets, or four sets of low-voltage windings. The rectifier REC2-A is connected to the low-voltage winding 1 of the rectifier transformer T2, outputs a direct current, and is connected to the load F2-A through a direct current bus. The rectifier REC2-B is connected to the low-voltage winding 2 of the rectifier transformer T2, outputs a direct current, and is connected to the load F2-B through a direct current bus. Therefore, this embodiment of this disclosure implements a set of high-voltage switches. One rectifier transformer has a plurality of windings, is connected to a plurality of rectifiers, and is connected to two or more heating furnaces 310. This solution features a multi-pulse rectifier, reduces harmonics, and reduces interference of harmonics to the power grid.

It may be understood that, in some examples, the rectifier transformer unit 600 includes a plurality of output windings, and the power distribution system 700, at least two output windings connected in parallel, and one heating furnace 310 are connected successively to form a third power supply path. For example, in the example of FIG. 15, a power supply is connected from the upper power grid U1 or U3, and power transmission and power cut of the rectifier transformer T3 are controlled through the high-voltage switch CB3. The rectifier transformer T3 has an on-load tap changer, which can adjust an output voltage. The rectifier transformer T3 has two sets, three sets, or four sets of low-voltage windings. The rectifier REC3-A is connected to the low-voltage winding 1 of the rectifier transformer T3, outputs a direct current, and is connected to the load F3 through a direct current bus. The rectifier REC3-B is connected to the low-voltage winding 2 of the rectifier transformer T3, outputs a direct current, and is connected to the load F3 through a direct current bus. Therefore, this embodiment of this disclosure implements a set of high-voltage switches. One rectifier transformer has a plurality of windings, is connected to a plurality of rectifiers, and is connected to one heating furnace 310. This solution features a multi-pulse rectifier, reduces harmonics, and reduces interference to the power grid.

It should be noted that the plurality of heating furnaces 310 in the production system 10 may form the first power supply path, the second power supply path, or the third power supply path, or may form two or three of the three power supply paths. This is not limited in embodiments of this disclosure.

It should be noted that the power distribution system 700 in this embodiment of this disclosure may alternatively be, but not limited to, configured to be electrically connected to the granulation unit 100, the precarbonization unit 200, the pretreatment unit 400, the finished product preparation unit 500, or the like. This is not limited in embodiments of this disclosure.

Referring to FIG. 8 and FIG. 13 again, the production system 10 in this embodiment of this disclosure further includes a control system 800 and a public facility system 900. The public facility system 900 includes at least one of a shielding gas system 910, a cooling system 920, an exhaust system 930, or an auxiliary gas system 940. The control system 800 is electrically connected to at least one of the shielding gas system 910, the cooling system 920, the exhaust system 930, or the auxiliary gas system 940.

It may be understood that the shielding gas system 910 is configured to output shielding gas. Each heating furnace 310 is disposed at a gas inlet 322, and the shielding gas system 910 communicates with the gas inlet 322 and transfers the shielding gas to the heating furnace 310. The shielding gas may be but is not limited to nitrogen, argon, or the like. Because a material (for example, a precarbonized material or a graphitized material) carries air when entering or leaving the heating furnace 310, if protection is not provided, oxidation and ignition easily occur when the material in the heating furnace 310 contacts the air at a high temperature, which decreases a material yield, makes some parameters of the material unqualified to decrease a material qualification rate, and also increases a safety risk of the heating furnace 310. In this disclosure, the shielding gas system 910 is disposed. In a heating process of the heating furnace 310, protection is provided by using shielding gas such as nitrogen and argon, which reduces consumption of the material, increases a material yield, and improves product quality. Shielding gas systems 910 of a plurality of heating furnaces 310 may be disposed separately, or a same shielding gas system 910 may be shared.

It may be understood that the cooling system 920 is configured to output a coolant medium. For example, the cooling system 920 is configured to output circulating water. Because a temperature of the material is high when the material is discharged from the heating furnace 310, the cooling system 920 in this disclosure can cool the discharged material of the heating furnace 310. Cooling systems 920 of a plurality of heating furnaces 310 may be disposed separately, or a same cooling system 920 may be shared.

It may be understood that the exhaust system 930 is configured to process volatile gas, dust, waste gas, and the like that are generated in the production process. Because impurities such as ash and volatile of the material (from a negative electrode raw material to a finished material) in the heating process may become gas and be discharged, which may contain some gas that affects the environment, the exhaust system 930 performs gas treatment, and then discharges the gas that has been treated and meets discharge indexes. Exhaust systems 930 of various apparatus of the production system 10 may be disposed separately, or various apparatuses of the production system 10 may share a same exhaust system 930.

It may be understood that the auxiliary gas system 940 is configured to transfer auxiliary gas, and the auxiliary gas can be applied to material pneumatic conveying, a pneumatic component, and the like. The auxiliary gas may be but is not limited to compressed air. It may be understood that in some examples, the shielding gas transferred by the shielding gas system 910 may alternatively be reused as the auxiliary gas. Auxiliary gas systems 940 of various apparatus of the production system 10 may be disposed separately, or various apparatuses of the production system 10 may share a same auxiliary gas system 940.

It may be understood that the control system 800 is electrically connected to the shielding gas system 910, the cooling system 920, the exhaust system 930, and the auxiliary gas system 940. The control system 800 may alternatively be electrically connected to a temperature control system and a measurement system of the production system 10. Therefore, the control system 800 can implement integrated control of systems such as power supply, circulating water, gas supply, feeding, discharge, cooling, exhaust, dust removal, heating furnace 310, temperature measurement and level measurement of the production system 10.

Various apparatuses of the production system 10 in this embodiment of this disclosure may share the shielding gas system 910, the cooling system 920, the exhaust system 930, the auxiliary gas system 940, and the power supply system, so as to save space and increase an integration level of the production system 10.

With reference to FIG. 8 to FIG. 15, referring to FIG. 1 to FIG. 7 again, the heating furnace 310 of the production system 10 in this disclosure may include the heating furnace 310 of any one of the foregoing embodiments. For example, the heating furnace 310 includes a furnace body 311, a first electrode 312, and a second electrode 313. The furnace body 311 is provided with an accommodation space 301. The first electrode 312 and the first electrode 313 have opposite polarities, at least a part of the first electrode 312 is disposed in the accommodation space 301, and the second electrode 313 is disposed in the accommodation space 301. In a radial direction H4 of the furnace body 311, the first electrode 312, the second electrode 313, and a sidewall 3111 of the furnace body 311 are successively arranged at intervals, so that a first channel 302 is formed between the first electrode 312 and the second electrode 313, and a second channel 303 is formed between the second electrode 313 and the sidewall 3111 of the furnace body 311. The second channel 303 and the first channel 302 extend in an axial direction H5 of the furnace body 311 and communicate with each other to form a material channel. The power distribution system 700 of the foregoing embodiments may be directly or indirectly electrically connected to the first electrode 312 and the second electrode 313 separately, to supply power to the first electrode 312 and the second electrode 313. For example, the power distribution system 700 is electrically connected to the first electrode 312 through a first power supply conductor 316, and is electrically connected to the second electrode 313 through a second power supply conductor 317.

In the heating furnace 310 in this embodiment of this disclosure, when the first electrode 312 and the second electrode 313 are energized, a material can be heated by an electric field formed by the first electrode 312 and the second electrode 313 when flowing in the first channel 302. On the one hand, a spatial volume of the first channel 302 between the first electrode 312 and the second electrode 313 is small, and an amount of materials accommodated in a same time period is small, the two electrodes heat the material in the first channel 302 with a higher heating power density, a faster heating speed of the material, and more uniform heating of the material. On the other hand, the material in this disclosure flows in the first channel 302 and the second channel 303, a flow path of the material is longer, the material is heated at a high temperature in the furnace body 311 for a longer time, so that the material can fully use heat in the furnace body 311, thereby improving heat utilization of the furnace body 311, and further improving energy utilization of the entire heating furnace 310.

In some examples, a material inlet 3114 and a material outlet 3115 are disposed in the furnace body 311, one end of the first channel 302 communicates with the material inlet 3114, the other end of the first channel 302 communicates with one end of the second channel 303, the other end of the second channel 303 communicates with the material outlet 3115, and both the material inlet 3114 and the material outlet 3115 are located on a same side of the two channels. A material enters the first channel 302 from the material inlet 3114, flows through the second channel 303, and is discharged from the material outlet 3115.

In some examples, the heating furnace 310 is a vertical heating furnace (for example, a vertical continuous heating furnace), and both the material inlet 3114 and the material outlet 3115 are disposed at a bottom of the furnace body 311.

In some examples, the second electrode 313 includes an annular structure, at least a part of the first electrode 312 is located in annular space of the second electrode 313, and the annular space is configured to form the first channel 302.

In some examples, the first electrode 312 may be but is not limited to a columnar electrode. In some examples, the second electrode 313 may be an annular electrode. By way of example but not limiting, the second electrode 313 is a cylindrical annular electrode or a square annular electrode.

In some examples, the heating furnace 310 further includes an adjustment unit 319, and the adjustment unit 319 is configured to adjust an overlapping length of the first electrode 312 and the second electrode 313 in the axial direction H5 of the furnace body 311.

In some examples, the adjustment unit 319 is configured to drive at least one of the first electrode 312 and the second electrode 313 to move in the axial direction H5 of the furnace body 311.

In some examples, the heating furnace 310 further includes a clamping member 314, and the clamping member 314 is configured to fix the first electrode 312 through clamping. The clamping member 314 may alternatively release limitation on the first electrode 312, so that the first electrode 312 moves in the axial direction H5 of the furnace body 311.

In some examples, the heating furnace 310 further includes an insulating member 315. The insulating member 315 is a non-conductive structure, and the insulating member 315 is located between the clamping member 314 and the furnace cover 3113, so as to avoid a short circuit because the clamped first electrode 312 contacts the furnace cover 3113 or the furnace body 311.

In some examples, the heating furnace 310 further includes a thermal insulation structure 321, and the thermal insulation structure 321 is disposed around an outer surface of the sidewall 3111 of the furnace body 311. The thermal insulation structure 321 can reduce a temperature outward diffusion rate of the furnace body 311, to reduce heat loss.

In some examples, the heating furnace 310 further includes a gas inlet 322 for introducing shielding gas and a gas outlet 323, and both the gas inlet 322 and the gas outlet 323 communicate with the accommodation space 301.

It should be noted that for the heating furnace 310 of the production system 10 in this embodiment of this disclosure, descriptions of any one of the foregoing embodiments may be referenced. Details are not described herein again.

Based on the foregoing description of the production system 10, an embodiment of this disclosure further provides a battery preparation system 20. Referring to FIG. 16, FIG. 16 is an example schematic diagram of a structure of the battery preparation system 20 according to an embodiment of this disclosure. The battery preparation system 20 includes the production system 10 in any one of the foregoing embodiments, and the production system 10 is configured to prepare a negative electrode material of a lithium battery.

It may be understood that the battery preparation system 20 may further include but is not limited to a positive electrode material production system 10, a positive electrode dispensing apparatus, a negative electrode dispensing apparatus, a coating apparatus, a positive electrode preparing apparatus, and a negative electrode preparing apparatus. A specific structure of the battery preparation system 20 is not limited in embodiments of this disclosure.

It should be noted that in the foregoing embodiments, descriptions of the embodiments are emphasized differently. For a part that is not described in detail in an embodiment, refer to the foregoing detailed description of the heating furnace 310 and the production system 10. Details are not described herein again.

It should be noted that “a plurality of” mentioned in this disclosure generally refers to two or more. In addition, a directional term mentioned in embodiments of this disclosure, such as “up”, “down”, “front”, “rear”, “left”, “right”, “inside”, “outside”, and “side”, is merely a direction in the accompanying drawings. Therefore, the directional term is used to describe and understand embodiments of this disclosure, and is not intended to limit embodiments of this disclosure. In the accompanying drawings, units with similar structures are denoted by a same reference numeral. For clarity, parts in the accompanying drawings are not drawn to scale. In addition, some related parts may not be shown in the accompanying drawings.

It should be noted that in the description of this disclosure, terms such as “first” and “second” are merely used to distinguish between similar objects, and cannot be understood as indicating or implying relative importance or implicitly indicating the quantity of indicated technical features.

The heating furnace, the production system, and the battery preparation system that are provided in this disclosure are described in detail above. The principle and implementations of this disclosure are described herein by using specific instances. The descriptions of the foregoing embodiments are merely intended to help understand this disclosure. In addition, a person skilled in the art may change a specific implementation and an disclosure scope based on the idea of this disclosure. In conclusion, content of this specification should not be construed as a limitation on this disclosure.

What is claimed is:

1. A heating furnace comprising:
a furnace body provided with an accommodation space;
a first electrode; and
a second electrode having a polarity opposite to that of the first electrode,
wherein:
at least a part of the first electrode is disposed in the accommodation space;
the second electrode is disposed in the accommodation space; and
in a radial direction of the furnace body, the first electrode, the second electrode, and a sidewall of the furnace body are successively arranged at intervals, so that a first channel is formed between the first electrode and the second electrode, a second channel is formed between the second electrode and the sidewall, and the second channel and the first channel extend in an axial direction of the furnace body and communicate with each other to form a material channel.

2. The heating furnace according to claim 1, wherein:
the furnace body is further provided with a material inlet and a material outlet; and
one end of the first channel communicates with the material inlet, the other end of the first channel communicates with one end of the second channel, and the other end of the second channel communicates with the material outlet.

3. The heating furnace according to claim 2, wherein:
the heating furnace is a vertical heating furnace; and
both the material inlet and the material outlet are disposed at a bottom of the furnace body.

4. The heating furnace according to claim 1, further comprising:
an adjustment unit configured to adjust an overlapping length of the first electrode and the second electrode in the axial direction of the furnace body.

5. The heating furnace according to claim 4, wherein:
the adjustment unit is configured to drive at least one of the first electrode and the second electrode to move in the axial direction of the furnace body.

6. The heating furnace according to claim 4, wherein the heating furnace further comprises:
a clamping member configured to fix the first electrode through clamping or release the first electrode, so that the first electrode moves in the axial direction of the furnace body.

7. The heating furnace according to claim 6, wherein:
the clamping member is configured to clamp a part that is of the first electrode and that is located outside the accommodation space;
the furnace body further comprises a furnace cover; and
the heating furnace further comprises an insulating member located between the clamping member and the furnace cover.

8. The heating furnace according to claim 1, wherein:
the second electrode comprises an annular structure;
at least a part of the first electrode is located in an annular space of the second electrode; and
the annular space is configured to form the first channel.

9. The heating furnace according to claim 8, wherein the first electrode comprises a cylindrical structure or a square columnar structure.

10. The heating furnace according to claim 8, wherein at least one of the first electrode and the second electrode comprises a graphite electrode.

11. The heating furnace according to claim 1, further comprising:
a thermal insulation structure disposed around an outer surface of the sidewall of the furnace body.

12. The heating furnace according to claim 1, further comprising:
a power supply apparatus configured to supply power to the first electrode and the second electrode, wherein:
the power supply apparatus is electrically connected to the first electrode through a first power supply conductor and is electrically connected to the second electrode through a second power supply conductor.

13. The heating furnace according to claim 1, further comprising:
a gas inlet for introducing shielding gas; and
a gas outlet, wherein:
both the gas inlet and the gas outlet communicate with the accommodation space.

14. A production system comprising a heating furnace capable of performing a graphitization process and/or a high temperature carbonization process, wherein the heating furnace comprises:
a furnace body provided with an accommodation space;
a first electrode; and
a second electrode having a polarity opposite to that of the first electrode,
wherein:
at least a part of the first electrode is disposed in the accommodation space;
the second electrode is disposed in the accommodation space; and
in a radial direction of the furnace body, the first electrode, the second electrode, and a sidewall of the furnace body are successively arranged at intervals, so that a first channel is formed between the first electrode and the second electrode, a second channel is formed between the second electrode and the sidewall, and the second channel and the first channel extend in an axial direction of the furnace body and communicate with each other to form a material channel.

15. The production system according to claim 14, wherein:
the furnace body is further provided with a material inlet and a material outlet;
one end of the first channel communicates with the material inlet, the other end of the first channel communicates with one end of the second channel, and the other end of the second channel communicates with the material outlet;
the heating furnace is a vertical heating furnace; and
both the material inlet and the material outlet are disposed at a bottom of the furnace body.

16. The production system according to claim 14, wherein the heating furnace further comprises:
an adjustment unit configured to adjust an overlapping length of the first electrode and the second electrode in the axial direction of the furnace body.

17. A production system comprising:
a granulation unit that performs a granulation process on a prefabricated material to obtain a coating material;
a precarbonization unit that performs a precarbonization process on the coating material to obtain a precarbonized material; and
a plurality of heating units that perform a graphitization process and/or a high temperature carbonization process on the precarbonized material,
wherein:
the granulation unit, the precarbonization unit, and the heating units are successively connected;
both the granulation unit and the precarbonization unit extend in a first direction;
the plurality of heating units are arranged and disposed in a second direction different from the first direction; and
in the first direction, the granulation unit and the precarbonization unit are disposed on a same side of the plurality of heating units.

18. The production system according to claim 17, further comprising:
a plurality of granulation units including the granulation unit, and
a plurality of precarbonization units including the precarbonization unit,
wherein:
each pair of granulation unit and precarbonization unit are arranged relative to one another in the first direction or the second direction and connected to form an entirety; and
the entirety is connected to one heating unit of the plurality of heating units, or at least two entireties are connected to one heating unit of the plurality of heating units.

19. The production system according to claim 18, wherein each precarbonization unit comprises:
a first end, and
a second end disposed opposite to the first end in the first direction,
wherein:
the second end is located between the first end and the heating unit;
one end of the granulation unit is flush with the first end along the second direction; and
a projection of the other end of the granulation unit on the precarbonization unit is located between the first end and the second end.

20. The production system according to claim 17, further comprising:
a plurality of granulation units including the granulation unit, and
a plurality of precarbonization units including the precarbonization unit,
wherein:
each pair of granulation unit and precarbonization unit are arranged in a third direction different from the first direction and the second direction and connected to form an entirety; and
the entirety is connected to one heating unit, or at least two entireties are connected to one heating unit.
